(19) United States
(12) Patent Application Publication
(10) Pub. No.: US 2026/0055263 A1
(43) Pub. Date: Feb. 26, 2026

(54) FLAME RETARDANT POLYMERIC COMPOSITIONS

(71) Applicant: Dow Global Technologies LLC, Midland, MI (US)

(72) Inventors: Karl M. Seven, Auburn, PA (US); Mohamed Esseghir, Monmouth, NJ (US); Michal Cermak, Wiesbaden (DE); Anthony Radesich, Wiesbaden (DE); Scott H. Wasserman, Collegeville, PA (US)

(21) Appl. No.: 19/104,857

(22) PCT Filed: Nov. 3, 2023
(86) PCT No.: PCT/US2023/078577

§ 371 Date: Feb. 19, 2025

Related U.S. Application Data
(60) Provisional application No. 63/383,795, filed on Nov. 15, 2022.

(51) Int. Cl. C08L 23/06; C08K 3/22; C08K 9/06

(52) U.S. Cl. CPC C08L 23/06; C08K 3/22; C08K 9/06; C08K 2003/2224; C08L 2201/02; C08L 2203/202; C08L 2205/025; C08L 2205/08; C08L 2207/062

(57) ABSTRACT

A polymeric composition includes a first ethylene-based polymer having a density of 0.93 g/cc to 0.97 g/cc as measured according to ASTM D792, a second ethylene-based polymer having a density of 0.93 g/cc to 0.97 g/cc as measured according to ASTM D792, wherein the second ethylene-based polymer has a melt index (I2) of 3.0 g/10 minute or greater as measured according to ASTM D1238, wherein the combination of the first and second ethylene-based polymers has a Relaxation Spectrum Index value of 10 to 25, a polydispersity index of 10 or greater as measured according to Gel Permeation Chromatography, and a dynamic oscillatory shear viscosity at 100 radians per second of 500 Pa·S or less as measured according to ASTM D4440-15. The polymeric composition also includes a compatibilizer and a flame retardant filler.

### BACKGROUND

### Field of the Disclosure

The present disclosure relates to polymeric compositions, and more specifically to flame retardant polymeric compositions.

### INTRODUCTION

Cables typically employ a polymeric composition around one or more conductors (i.e., optical and/or electrical). In such cables, flame retardancy may not be a key property considered for certain elements of the cables and as such the incorporation of flame-retardant materials in elements has been limited. Recently though, flame retardancy standards have been refocusing target properties on cables as a whole, rather than the individual components. Such a change has placed a new importance on flame retardancy of those components of the cable. For example, the inclusion of buffer tubes comprising traditional unfilled polyolefins or other buffer tubes without flame retardant additives may lead to failure of the cable as a whole with respect to flame retardancy even if other components like the jacketing are flame retardant. As such, the polymeric composition of buffer tubes should exhibit a Peak Heat Release Rate (PHRR) from cone calorimetry of less than 250 kilowatts per meter squared (“kW/m²”) as measured according to ASTM E1354 in order to comply with the new standards.

Traditional methods of adding flame retardancy to a polymeric composition include selecting a flexible base polyolefin (i.e., one having a low flexural modulus) and a flame-retardant filler for incorporation into the polyolefin. Utilizing this approach in buffer tubes is a challenging undertaking for a variety of reasons. First, the tensile elongation and flexural modulus of buffer tubes is important and the incorporation of typical low flexural modulus (e.g., 100 MPa to 200 MPa) polyolefin used in flame retardant polyolefins would result in inadequately low flexural modulus of the buffer tube. Typically a tensile elongation of greater than 20% and a flexural modulus of greater than 950 MPa for buffer tubes is necessary. Second, buffer tubes must process well at high extrusion speeds (i.e., no tube breakage or dimensional defects). However, halogen free flame retardant fillers (“HFFR”) are typically included at 60 wt % or more which leads to significant increase in melt viscosity compromising processability and also negatively impacting the final mechanical properties. In order to extrude fast enough to render buffer tubes commercially viable, a shear viscosity at relatively high shear rates, e.g., a dynamic oscillatory shear viscosity measured at 100 radians per second, which is indicative of how easy a material can be extruded, of the buffer tube material should be 500 pascal seconds (“Pa·s”) or less as measured according to ASTM D4440-15. Third, the mere incorporation of flame-retardant fillers is not enough to impart flame retardant properties. Without the proper compatibilization and dispersion the flame retardant filler may clump within the polymeric composition providing minimal flame retardant properties while also decreasing mechanical properties. Further, incomplete dispersion of the HFFR within the polymeric composition can result in the polymeric composition breaking or cracking when subjected to a Mandrel Bending Test. Such a result would suggest that a buffer tube composed of the polymeric composition could break or crack in service.

The combination of ionomers and maleic anhydride grafted polymers is known in the art. For example, U.S. Pat. No. 6,569,947B1 (“The '947 patent”). discloses a maleic anhydride modified ethylene polymer/ionomer/high density polyethylene blend useful in high impact resistant materials. However, such a blend was only believed to be beneficial for the improvement of impact properties and any effect on flame retardancy was unknown.

In view of the foregoing, it would be surprising to discover a polymeric composition exhibiting a PHRR of less than 250 kW/m² as measured according to ASTM E1354, an elongation of greater than 20% as measured according to ASTM D638, a flexural modulus of greater than 950 MPa as measured according to ASTM D790, a dynamic oscillatory shear viscosity at 100 radians per second of 500 Pa·s or less as measured according to ASTM D4440-15 and not break or crack when subjected to a Mandrel Bending Test.

### SUMMARY OF THE DISCLOSURE

The inventors of the present application have discovered a polymeric composition exhibiting a PHRR of less than 250 kW/m² as measured according to ASTM E1354, an elongation of greater than 20% as measured according to ASTM D638, a flexural modulus of greater than 950 MPa as measured according to ASTM D790, a dynamic oscillatory shear viscosity at 100 radians per second of 500 Pa·s or less as measured according to ASTM D4440-15 and will not break or crack when subjected to a Mandrel Bending Test.

The invention is a result of discovering that a polymeric composition comprising a blend of ethylene-based polymers, a flame-retardant filler and a compatibilizer can achieve the above-noted properties. Specifically, it has been discovered that by utilizing a blend of high-density ethylene-based polymers these results can be achieved. Specifically, the blend should include a first ethylene-based polymer with a broad molecular weight distribution and a low melt index and a second ethylene-based polymer with a narrow molecular weight distribution but having a high melt index, with the blend exhibiting a relaxation spectrum index of 10 to 25, a polydispersity index of 10 or greater as measured according to Gel Permeation Chromatography, and a dynamic oscillatory shear viscosity at 100 radians per second of 500 Pa·s or less as measured according to ASTM D4440-15. Without being bound by theory, it is believed that the low melt index of the first ethylene-based polymer provides sufficient viscous shear induced stresses to disperse the HFFR filler during melt mixing thereby homogenizing the filler in the polymer matrix and thus achieving effective flame retardancy as well as mechanical properties. It is believed that the high melt index of the second ethylene-based polymer aids in reducing the overall compound viscosity and thus aids in the processability of the polymeric composition. Additionally, the highlighted Relaxation Spectrum Index (RSI) and polydispersity index improve the physical properties of the blend such that high speed extrusion can be achieved despite the incorporation of a high level of filler. By combining the two ethylene-based polymers, the compatibilizer and the silane-treated flame retardant filler, the above-noted properties can be achieved in a polymeric composition. Furthermore, the removal of undispersed particles greater than 140 μm via melt filtering during the compound manufacturing step reduces possible defects during high-speed extrusion of thin wall buffer tubes.

According to a first feature of the present disclosure, a polymeric composition, comprises a first ethylene-based polymer having a density of 0.93 g/cc to 0.97 g/cc as measured according to ASTM D792, wherein the first ethylene-based polymer has a melt index (I₂) of 0.8 g/10 minute or less as measured according to ASTM D1238; a second ethylene-based polymer having a density of 0.93 g/cc to 0.97 g/cc as measured according to ASTM D792, wherein the second ethylene-based polymer has a melt index (I₂) of 3.0 g/10 minute or greater as measured according to ASTM D1238, wherein the combination of the first and second ethylene-based polymers has a Relaxation Spectrum Index value of 10 to 25, a polydispersity index of 10 or greater as measured according to Gel Permeation Chromatography, and a dynamic oscillatory shear viscosity at 100 radians per second of 500 Pa·S or less as measured according to ASTM D4440-15; a compatibilizer; and a flame retardant filler.

According to a second feature of the present disclosure, the compatibilizer is selected from the group consisting of a maleic anhydride grafted polymer, an acid copolymer, and an ionomer.

According to a third feature of the present disclosure, the flame retardant filler is a silane-treated flame retardant filler and the polymeric composition comprises from 10 wt % to 80 wt % of the silane treated flame retardant filler based on a total weight of the polymeric composition.

According to a fourth feature of the present disclosure, the polymeric composition comprises from 5 wt % to 30 wt % of the first ethylene-based polymer based on a total weight of the polymeric composition.

According to a fifth feature of the present disclosure, the polymeric composition comprises from 1 wt % to 20 wt % of the second ethylene-based polymer based on a total weight of the polymeric composition.

According to a sixth feature of the present disclosure, a weight ratio of the first ethylene-based polymer to the second ethylene-based polymer is from 1:1 to 3:1.

According to a seventh feature of the present disclosure, the first ethylene-based polymer has a melt index (I₂) of 0.5 g/10 min or less as measured according to ASTM D1238 and the second ethylene-based polymer has a melt index (I₂) of 6 g/10 min or greater as measured according to ASTM D1238.

According to an eighth feature of the present disclosure, the Relaxation Spectrum Index value of the combined first and second ethylene-based polymer is 15 to 21.

According to a ninth feature of the present disclosure, the polymeric composition exhibits a PHHR of less than 250 kW/m² as measured according to ASTM E1354, an elongation of greater than 20% as measured according to ASTM D638, a flexural modulus of greater than 950 MPa as measured according to ASTM D790.

According to a tenth feature of the present disclosure, a cable, comprises a conductor; and a buffer tube positioned around the conductor and comprising the polymeric composition.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); IEC refers to International Electrotechnical Commission; EN refers to European Norm; DIN refers to Deutsches Institut für Normung; and ISO refers to International Organization for Standards.

As used herein, the term weight percent (“wt %”) designates the percentage by weight a component is of a total weight of the polymeric composition unless otherwise specified.

Melt index (I₂) values herein refer to values determined according to ASTM method D1238 at 190 degrees Celsius (C) with 2.16 Kilogram (Kg) mass and are provided in units of grams eluted per ten minutes (“g/10 min”).

Density values herein refer to values determined according to ASTM D792 at 23° C. and are provided in units of grams per cubic centimeter (“g/cc”).

As used herein, Chemical Abstract Services registration numbers (“CAS #”) refer to the unique numeric identifier as most recently assigned as of the priority date of this document to a chemical compound by the Chemical Abstracts Service.

### Polymeric Composition

The present disclosure is directed to a polymeric composition. The polymeric composition comprises a first ethylene-based polymer, a second ethylene-based polymer, a compatibilizer and a silane-treated flame retardant filler.

The polymeric composition may exhibit a variety of properties. The polymeric composition may exhibit a PHRR of less than 250 kW/m² as measured using cone calorimetry according to ASTM E1354. For example, the polymeric composition may exhibit a PHRR of less than 250 kW/m², or 240 kW/m² or less, or 230 kW/m² or less, or 220 kW/m² or less, or 210 kW/m² or less, or 200 kW/m² or less, or 190 kW/m² or less, or 180 kW/m² or less, or 170 kW/m² or less, or 160 kW/m² or less, or 150 kW/m² or less, or 140 kW/m² or less, or 130 kW/m² or less, or 120 kW/m² or less, or 110 kW/m² or less, or 100 kW/m² or less, or 90 kW/m² or less, or 80 kW/m² or less, or 70 kW/m² or less, or 60 kW/m² or less, or 50 kW/m² or less as measured according to ASTM E1354.

The polymer composition may exhibit an elongation at break of greater than 20% as measured according to ASTM D638. For example, the polymer composition may exhibit an elongation at break of 21% or greater, or 22% or greater, or 23% or greater, or 24% or greater, or 25% or greater, or 26% or greater, or 27% or greater, or 28% or greater, or 29% or greater, or 30% or greater, or 40% or greater, or 50% or greater, or 75% or greater, or 100% or greater, or 175% or greater, or 180% or greater, or 190% or greater, or 200% or greater, or 225% or greater, or 250% or greater, or 275% or greater or 300% or greater, while at the same time, 350% or less, or 300% or less, or 250% or less, or 200% or less, or 150% or less, or 100% or less, or 50% or less, or 30% or less as measured according to ASTM D638.

The polymeric composition may exhibit a flexural modulus of 950 MPa or greater. For example the polymeric composition may exhibit a flexural modulus of 950 MPa or greater, or 1.000 MPa or greater, or 1.100 MPa or greater, or 1,200 MPa or greater, or 1.300 MPa or greater, or 1,400 MPa or greater, or 1,500 MPa or greater, or 1,600 MPa or greater, or 1,700 MPa or greater, or 1,800 MPa or greater, or 1,900 MPa or greater, or 2,000 MPa or greater, or 2,100 MPa or greater, or 2,200 MPa or greater, or 2,300 MPa or greater, or 2,400 MPa or greater, or 2,500 MPa or greater, or 2,600 MPa or greater, or 2,700 MPa or greater, or 2,800 MPa or greater, or 2,900 MPa or greater, while at the same time, 3,000 MPa or less, or 2,900 MPa or less, or 2,800 MPa or less, or 2,700 MPa or less, or 2,600 MPa or less, or 2,500 MPa or less, or 2,400 MPa or less, or 2,300 MPa or less, or 2,200 MPa or less, or 2,100 MPA or less, or 2,000 MPa or less, or 1,900 MPa or less, or 1,800 MPa or less, or 1,700 MPa or less, or 1,600 MPa or less, or 1,500 MPa or less, or 1,400 MPa or less, or 1,300 MPa or less, or 1,200 MPa or less, or 1,100 MPA or less, or 1,000 MPa or less as measured according to ASTM D790.

The polymeric composition may exhibit a dynamic oscillatory shear viscosity at 0.1 radians per second less than 46,000 Pa·s as measured according to ASTM D4440-15. For example, the polymeric composition may exhibit a dynamic oscillatory shear viscosity at 0.1 radians per second less than 46,000 Pa·s, or 40,000 Pa·s or less, or 35,000 Pa·s or less, or 30,000 Pa·s or less, or 25,000 Pa·s or less, or 20,000 Pa·s or less, or 15,000 Pa·s or less, or 10,000 Pa·s or less as measured according to ASTM D4440-15.

The polymeric composition may exhibit a dynamic oscillatory shear viscosity at 100 radians per second of 500 Pa·s or less as measured according to ASTM D4440-15. For example, the polymeric composition may exhibit a dynamic oscillatory shear viscosity at 100 radians per second of 1 Pa·s or greater, or 10 Pa·s or greater, or 50 Pa·s or greater, or 100 Pa·s or greater, or 150 Pa·s or greater, or 200 Pa·s or greater, or 250 Pa·s or greater, or 300 Pa·s or greater, or 350 Pa·s or greater, or 400 Pa·s or greater, or 450 Pa·s or greater, while at the same time, 500 Pa·s or less, or 450 Pa·s or less, or 400 Pa·s or less, or 350 Pa·s or less, or 300 Pa·s or less, or 250 Pa·s or less, or 200 Pa·s or less, or 150 Pa·s or less, or 10 Pas or less, or 50 Pa·s or less as measured according to ASTM D4440-15.

### First Ethylene-Based Polymer

As noted above, the composition may comprise the first ethylene-based polymer. As used herein, “ethylene-based” polymers are polymers in which greater than 50 wt % of the monomers are ethylene though other co-monomers may also be employed. Ethylene-based polymers include ethylene and one or more C₃-C₂₀ α-olefin comonomers such as propylene, 1-butene, 1 pentene, 4-methyl-1-pentene, 1-hexene, and 1-octene.

The ethylene-based polymer may comprise 50 wt % or greater, 60 wt % or greater, 70 wt % or greater, 80 wt % or greater, 85 wt % or greater, 90 wt % or greater, or 91 wt % or greater, or 92 wt % or greater, or 93 wt % or greater, or 94 wt % or greater, or 95 wt % or greater, or 96 wt % or greater, or 97 wt % or greater, or 97.5 wt % or greater, or 98 wt % or greater, or 99 wt % or greater, while at the same time, 99.5 wt % or less, or 99 wt % or less, or 98 wt % or less, or 97 wt % or less, or 96 wt % or less, or 95 wt % or less, or 94 wt % or less, or 93 wt % or less, or 92 wt % or less, or 91 wt % or less, or 90 wt % or less, or 85 wt % or less, or 80 wt % or less, or 70 wt % or less, or 60 wt % or less of ethylene monomers as measured using Nuclear Magnetic Resonance (NMR) or Fourier-Transform Infrared (FTIR) Spectroscopy.

Other units of ethylene-based polymers may be derived from one or more polymerizable monomers including, but not limited to, polar monomers such as unsaturated esters. The unsaturated esters (i.e. polar monomers) may be alkyl acrylates, alkyl methacrylates, or vinyl carboxylates. The alkyl groups can have from 1 to 8 carbon atoms, or from 1 to 4 carbon atoms. The carboxylate groups can have from 2 to 8 carbon atoms, or from 2 to 5 carbon atoms. Examples of acrylates and methacrylates include, but are not limited to, ethyl acrylate, methyl acrylate, methyl methacrylate, t-butyl acrylate, n-butyl acrylate, n-butyl methacrylate, and 2 ethylhexyl acrylate. Examples of vinyl carboxylates include, but are not limited to, vinyl acetate, vinyl propionate, and vinyl butanoate. The ethylene-based polymer may have a polar comonomer content of 40 wt % or less, or 35 wt % or less, or 30 wt % or less, or 25 wt % or less, or 20 wt % or less, 15 wt %, or 10 wt %, or 5 wt % or less, or 3 wt % or less, or 1 wt % or less, or 0 wt % based on the total weight of the ethylene-based polymer as measured using Nuclear Magnetic Resonance (NMR) or Fourier-Transform Infrared (FTIR) Spectroscopy.

The ethylene-based polymer can have a unimodal or a multimodal molecular weight distribution and can be used alone or in combination with one or more other types of ethylene-based polymers (e.g., a blend of two or more ethylene-based polymers that differ from one another by monomer composition and content, catalytic method of preparation, molecular weight, molecular weight distributions, densities, etc.). If a blend of ethylene-based polymers is employed, the polymers can be blended by any in-reactor or post-reactor process. The term “multimodal polymer” refers to polymers that are characterized by having at least two distinct peaks in a gel permeation chromatography (GPC) chromatogram depicting the molecular weight distribution of the composition. Accordingly, the generic term multimodal polymer includes bimodal polymers, which have two primary fractions: a first fraction, which may be a low molecular weight fraction and/or component, and a second fraction, which may be a high molecular weight fraction and/or component.

The density of the first ethylene-based polymer is from 0.93 g/cc to 0.97 g/cc as measured according to ASTM D792. For example, the density of the first ethylene-based polymer is 0.930 g/cc or greater, or 0.935 g/cc or greater, or 0.940 g/cc or greater, 0.945 g/cc or greater, or 0.950 g/cc or greater, or 0.955 g/cc or greater, or 0.960 g/cc or greater, or 0.965 g/cc or greater, while at the same time, 0.970 g/cc or less, or 0.965 g/cc or less, or 0.960 g/cc or less, or 0.955 g/cc or less, or 0.950 g/cc or less, or 0.945 g/cc or less, or 0.940 g/cc or less, or 0.935 g/cc or less as measured according to ASTM D792. Generally, ethylene-based polymers having a density of 0.93 g/cc to 0.97 g/cc are referred to as a “high density polyethylene” or “HDPE”.

The first ethylene-based polymer has a melt index (I₂) of 0.8 g/10 minute or less as measured according to ASTM D1238. For example, the first ethylene-based polymer has a melt index (I₂) of 0.8 g/10 minute or less, or 0.7 g/10 minute or less, or 0.6 g/10 minute or less, or 0.5 g/10 minute or less, or 0.4 g/10 minute or less, or 0.3 g/10 minute or less, or 0.2 g/10 minute or less, or 0.1 g/10 minute or less as measured according to ASTM D1238.

The polymeric composition may comprise 5 wt % to 30 wt % of the first ethylene-based polymer based on a total weight of the polymeric composition. For example, the polymeric composition may comprise 5 wt % or greater, or 10 wt % or greater, or 15 wt % or greater, or 20 wt % or greater, or 25 wt % or greater, while at the same time, 30 wt % or less, or 25 wt % or less, or 20 wt % or less, or 15 wt % or less, or 10 wt % or less of the first ethylene-based polymer based on the total weight of the polymeric composition.

### Second Ethylene-Based Polymer

The polymeric composition comprises the second ethylene-based polymer. The second ethylene-based polymer

The density of the second ethylene-based polymer is from 0.93 g/cc to 0.97 g/cc as measured according to ASTM D792. For example, the density of the second ethylene-based polymer is 0.930 g/cc or greater, or 0.935 g/cc or greater, or 0.940 g/cc or greater, 0.945 g/cc or greater, or 0.950 g/cc or greater, or 0.955 g/cc or greater, or 0.960 g/cc or greater, or 0.965 g/cc or greater, while at the same time, 0.970 g/cc or less, or 0.965 g/cc or less, or 0.960 g/cc or less, or 0.955 g/cc or less, or 0.950 g/cc or less, or 0.945 g/cc or less, or 0.940 g/cc or less, or 0.935 g/cc or less as measured according to ASTM D792.

The second ethylene-based polymer has a melt index (I₂) of 3.0 or g/10 minute or greater as measured according to ASTM D1238. For example, the 3.0 or g/10 minute or greater, or 3.5 or g/10 minute or greater, or 4.0 or g/10 minute or greater, or 4.5 or g/10 minute or greater, or 5.0 or g/10 minute or greater, or 5.5 or g/10 minute or greater, or 6.0 or g/10 minute or greater, or 6.5 or g/10 minute or greater, or 7.0 or g/10 minute or greater, or 7.5 or g/10 minute or greater, or 8.0 or g/10 minute or greater, or 8.5 or g/10 minute or greater, or 9.0 or g/10 minute or greater, or 9.5 or g/10 minute or greater, while at the same time, 10.0 g/10 minute or less, or 9.5 g/10 minute or less, or 9.0 g/10 minute or less, or 8.5 g/10 minute or less, or 8.0 g/10 minute or less, or 7.5 g/10 minute or less, or 7.0 g/10 minute or less, or 6.5 g/10 minute or less, or 6.0 g/10 minute or less, or 5.5 g/10 minute or less, or 5.0 g/10 minute or less, or 4.5 g/10 minute or less, or 4.0 g/10 minute or less, or 3.5 g/10 minute or less as measured according to ASTM D1238.

The polymeric composition may comprise 1 wt % to 20 wt % of the second ethylene-based polymer based on a total weight of the polymeric composition. For example, the polymeric composition may comprise 1 wt % or greater, or 2 wt % or greater, or 4 wt % or greater, or 6 wt % or greater, or 8 wt % or greater, or 10 wt % or greater, or 12 wt % or greater, or 14 wt % or greater, or 16 wt % or greater, or 18 wt % or greater, while at the same time, 20 wt % or less, or 18 wt % or less, or 16 wt % or less, or 14 wt % or less, or 12 wt % or less, or 10 wt % or less, or 8 wt % or less, or 6 wt % or less, or 4 wt % or less, or 2 wt % or less of the second ethylene-based polymer based on the total weight of the polymeric composition.

The polymeric composition may have a weight ratio of the first ethylene-based polymer to the second ethylene-based polymer from 1:1 to 3:1. The weight ratio of the first ethylene-based polymer to the second ethylene-based polymer is determined by dividing the weight percent of the first ethylene-based polymer in the polymeric composition based on the total weight of the polymeric composition by the weight percent of the second ethylene-based polymer in the polymeric composition based on the total weight of the polymeric composition and using that quotient as X in the expression “X: 1” to represent the weight ratio. The weight ratio of the first ethylene-based polymer to the second ethylene-based polymer from 1:1 or greater, or 1.2:1 or greater, or 1.4:1 or greater, or 1.6:1 or greater, or 1.8:1 or greater, or 2.0:1 or greater, or 2.2:1 or greater, or 2.4:1 or greater, or 2.6:1 or greater, or 2.8:1 or greater, or 3:1.

### Combined First and Second Ethylene-Based Polymers

The combined first and second ethylene-based polymers have a Relaxation Spectrum Index value of 10 to 25 as calculated from dynamic oscillatory shear testing as explained in greater detail below. For example, the RSI value may be 10 or greater, or 11 or greater, or 12 or greater, or 13 or greater, or 14 or greater, or 15 or greater, or 16 or greater, or 17 or greater, or 18 or greater, or 19 or greater, or 20 or greater, or 21 or greater, or 22 or greater, or 23 or greater, or 24 or greater, while at the same time, or 25 or less, or 24 or less, or 23 or less, or 22 or less, or 21 or less, or 20 or less, or 19 or less, or 18 or less, or 17 or less, or 16 or less, or 15 or less, or 14 or less, or 13 or less, or 12 or less, or 11 or less as calculated from dynamic oscillatory shear testing.

The combined first and second ethylene-based polymers have a Polydispersity Index value of greater than 10 as measured according to Gel Permeation Chromatography. For example, the Polydispersity Index value may be 10.1 or greater, or 11 or greater, or 12 or greater, or 13 or greater, or 14 or greater, or 15 or greater, or 16 or greater, or 17 or greater, or 18 or greater, or 19 or greater, or 20 or greater, or 21 or greater, or 22 or greater, or 23 or greater, or 24 or greater, while at the same time, 25 or less, or 24 or less, or 23 or less, or 22 or less, or 21 or less, or 20 or less, or 19 or less, or 18 or less, or 17 or less, or 16 or less, or 15 or less, or 14 or less, or 13 or less, or 12 or less, or 11 or less as measured according to Gel Permeation Chromatography.

### Compatibilizer

The polymeric composition comprises a compatibilizer. The compatibilizer may be one or more of a maleic anhydride grafted polymer, an acid copolymer, and an ionomer.

### Maleic Anhydride Functionalized Polyolefin

The polymeric composition may comprise a maleic anhydride functionalized polyolefin. As used herein, the term “maleic anhydride functionalized” indicates a polyolefin that has been modified to incorporate a maleic anhydride monomer. The maleic anhydride functionalized polyolefin can be formed by copolymerization of maleic anhydride monomer with ethylene and other monomers (if present) to prepare an interpolymer having maleic anhydride incorporated into the polymer backbone. Additionally, or alternatively, the maleic anhydride can be graft-polymerized to the polyolefin. The polyolefin that is maleic anhydride functionalized may be any of the previously discussed ethylene-based polymers.

The maleic anhydride functionalized polyolefin can have a density of 0.87 g/cc or greater, or 0.88 g/cc or greater, or 0.89 g/cc or greater, or 0.90 g/cc or greater, or 0.91 g/cc or greater, or 0.92 g/cc or greater, or 0.93 g/cc or greater, or 0.94 g/cc or greater, or 0.95 g/cc or greater, 0.96 g/cc or greater, while at the same time, 0.97 g/cc or less, or 0.965 g/cc or less, or 0.96 g/cc or less, or 0.95 g/cc or less, or 0.94 g/cc or less, or 0.93 g/cc or less, or 0.92 g/cc or less, or 0.91 g/cc or less, or 0.90 g/cc or less, or 0.89 g/cc or less, or 0.88 g/cc or less, or 0.87 g/cc or less as measured by ASTM D792.

The maleic anhydride functionalized polyolefin has an melt flow index of 1 g/10 min. or greater, or 2 g/10 min. or greater, 3 g/10 min. or greater, 4 g/10 min. or greater, 5 g/10 min. or greater, 6 g/10 min. or greater, 7 g/10 min. or greater, 8 g/10 min. or greater, 9 g/10 min. or greater, 10 g/10 min. or greater, or 11 g/10 min. or greater, or 12 g/10 min. or greater, 13 g/10 min. or greater, 14 g/10 min. or greater, 15 g/10 min. or greater, 16 g/10 min. or greater, 17 g/10 min. or greater, 18 g/10 min. or greater, 19 g/10 min. or greater, while at the same time, 20 g/10 min. or less, or 19 g/10 min. or less, or 18 g/10 min. or less, or 17 g/10 min. or less, or 16 g/10 min. or less, or 15 g/10 min. or less, or 14 g/10 min. or less, or 13 g/10 min. or less, or 12 g/10 min. or less, or 11 g/10 min. or less, or 10 g/10 min. or less, or 9 g/10 min. or less, or 8 g/10 min. or less, or 7 g/10 min. or less, or 6 g/10 min. or less, or 5 g/10 min. or less, or 4 g/10 min. or less, or 3 g/10 min. or less, or 2 g/10 min. or less. The MFI is measured in accordance with ASTM D1238 at 190° C. and 2.16 kg.

The maleic anhydride functionalized polyolefin can have a maleic anhydride content, based on the total weight of the maleic anhydride functionalized polyolefin, of 0.25 wt % or greater, or 0.50 wt % or greater, or 0.75 wt % or greater, or 1.00 wt % or greater, or 1.25 wt % or greater, or 1.50 wt % or greater, or 1.75 wt % or greater, or 2.00 wt % or greater, or 2.25 wt % or greater, or 2.50 wt % or greater, or 2.75 wt % or greater, while at the same time, 3.00 wt % or less, 2.75 wt % or less, or 2.50 wt % or less, or 2.25 wt % or less, or 2.00 wt % or less, or 1.75 wt % or less, or 1.50 wt % or less, or 1.25 wt % or less, or 1.00 wt % or less, or 0.75 wt % or less, or 0.5 wt % or less. Maleic anhydride concentrations are determined by Titration Analysis. Titration Analysis is performed by utilizing dried resin and titrates with 0.02N KOH to determine the amount of maleic anhydride. The dried polymers are titrated by dissolving 0.3 to 0.5 grams of maleic anhydride functionalized polyolefin in about 150 mL of refluxing xylene. Upon complete dissolution, deionized water (four drops) is added to the solution and the solution is refluxed for 1 hour. Next, 1% thymol blue (a few drops) is added to the solution and the solution is over titrated with 0.02N KOH in ethanol as indicated by the formation of a purple color. The solution is then back-titrated to a yellow endpoint with 0.05N HCl in isopropanol.

The polymeric composition may comprise 4 wt % or greater, or 5 wt % or greater, or 6 wt % or greater, or 7 wt % or greater, or 8 wt % or greater, or 9 wt % or greater, or 10 wt % or greater, or 11 wt % or greater, or 12 wt % or greater, or 13 wt % or greater, or 14 wt % or greater, or 15 wt % or greater, or 16 wt % or greater, or 17 wt % or greater, while at the same time, 18 wt % or less, or 17 wt % or less, or 16 wt % or less, or 15 wt % or less, or 14 wt % or less, or 13 wt % or less, or 12 wt % or less, or 11 wt % or less, or 10 wt % or less, or 9 wt % or less, or 8 wt % or less, or 7 wt % or less, or 6 wt % or less, or 5 wt % or less, or 4 wt % or less of maleic anhydride functionalized polyolefin based on the total weight of the polymeric composition.

An example of a suitable commercially available maleic anhydride functionalized polyolefin is AMPLIFY™ GR208 available from The Dow Chemical Company, Midland, MI, USA.

### Acid Copolymer and Ionomer

The polymeric composition comprises an acid copolymer and/or an ionomer. As used herein, the term “acid copolymer” means a copolymer that comprises repeat units derived from ethylene and 1 wt % to 50 wt of an acidic comonomer such as acrylic acid, methacrylic acid, ethacrylic acid, or combinations thereof, based on the total weight of the acid copolymer. As used herein, the term “ionomer” means an acid copolymer that has been partially or fully neutralized.

The acid copolymer or ionomer may comprise up to 35 wt % of an optional comonomer based on a total weight of the ionomer. Potential comonomers include carbon monoxide, sulfur dioxide, acrylonitrile, maleic anhydride, maleic acid diesters, maleic acid, maleic acid monoesters, itaconic acid, fumaric acid, fumaric acid monoester, a salt of these acids, glycidyl acrylate, glycidyl methacrylate, and glycidyl vinyl ether, methyl acrylate, ethyl acrylate, isopropyl acrylate, butyl acrylate, pentyl acrylate, methyl methacrylate, ethyl methacrylate, propyl methacrylate and butyl methacrylate, pentyl methacrylate, or combinations thereof where the alky group can be linear or branched.

The ionomer may have a wide degree of neutralization. For example, the ionomer can be neutralized at 0.1% or greater, or 1% or greater, or 10% or greater, or 15 wt % or greater, or 20% or greater, or 30% or greater, or 40% or greater, or 50% or greater, or 60% or greater, or 70% or greater, or 80% or greater, or 90% or greater, while at the same time, 100% or less, or 90% or less, or 80% or less, or 70% or less, or 60% or less, or 50% or less, or 40% or less, or 30% or less, or 20% or less, or 15 wt % or less, or 10% or less, or 5% or less based on the total acid content. The ionomer may be neutralized using one or more metallic ions. The metallic ions can be monovalent, divalent, trivalent, multivalent, or combinations thereof. Examples of suitable metallic ions include Li, Na, Ag, Hg, Cu, Be, Mg, Ca, Sr, Ba, Cd, Sn, Pb, Fe, Co, Zn, Ni, Al, Sc, Hf, Ti, Zr, Ce, K, Na and combinations thereof. If the metallic ion is multivalent, a complexing agent, such as stearate, oleate, salicylate, and phenolate radicals can be included.

The ionomer can be a blend of an ionomer having a greater than 20% neutralization and, for example, a second ethylene acid copolymer to achieve the desired degree of neutralization. For example, the ionomer can comprise 1 wt % to 50 wt % an acid copolymer disclosed above.

An example of a commercially available ionomer includes SURLYN™ ionomers available from The Dow Chemical Company, Midland, MI, USA.

The polymeric composition comprises from 1 wt % to 10 wt % of the acid copolymer and/or ionomer based on a total weight of the polymeric composition. For example, the polymeric composition comprises 1 wt % or greater, or 2 wt % or greater, or 3 wt % or greater, or 4 wt % or greater, or 5 wt % or greater, or 6 wt % or greater, or 7 wt % or greater, or 8 wt % or greater, or 9 wt % or greater, while at the same time, 10 wt % or less, or 9 wt % or less, or 8 wt % or less, or 7 wt % or less, or 6 wt % or less, or 5 wt % or less, or 4 wt % or less, or 3 wt % or less, or 2 wt % or less of one or more of the acid copolymer and/or ionomer based on a total weight of the polymeric composition.

### Flame Retardant Filler

The polymeric composition comprises a flame retardant filler. The flame retardant of the polymeric composition can inhibit, suppress, or delay the production of flames. Examples of the flame retardants suitable for use in the polymeric composition include, but are not limited to, metal hydroxides, metal carbonates, red phosphorous, silica, alumina, aluminum tri-hydroxide, magnesium hydroxide, titanium oxide, carbon nanotubes, talc, clay, organo-modified clay, calcium carbonate, zinc borate, antimony trioxide, wollastonite, mica, ammonium octamolybdate, frits, hollow glass microspheres, intumescent compounds, expanded graphite, and combinations thereof. Specifically, the halogen-free flame retardant can be selected from the group consisting of aluminum hydroxide, magnesium hydroxide, calcium carbonate, and combinations thereof. The flame-retardant filler may be silane-treated. The silane-treated flame-retardant filler is surface treated in a vinyl silane. In addition to the silane surface treatment, the flame retardant can optionally be surface treated (coated) with a saturated or unsaturated carboxylic acid having 8 to 24 carbon atoms, or 12 to 18 carbon atoms, or a metal salt of the acid. Exemplary surface treatments are described in U.S. Pat. Nos. 4,255,303, 5,034,442, 7,514,489, US 2008/0251273, and WO 2013/116283.

Commercially available examples flame retardants suitable for use in the polymeric composition include, but are not limited to, MAGNIFIN™ H5A magnesium hydroxide available from Magnifin Magnesiaprodukte GmbH & Co KG.

The polymeric composition may comprise the flame retardant filler in a concentration of 10 wt % to 80 wt % based on the total weight of the polymeric composition. For example, the polymeric composition may comprise the silane treated flame retardant filler in a concentration of 10 wt % or greater, or 20 wt % or greater, or 22 wt % or greater, or 24 wt % or greater, or 26 wt % or greater, or 28% or greater, or 30 wt % or greater, or 32 wt % or greater, or 34 wt % or greater, or 36 wt % or greater, or 38% or greater, or 40 wt % or greater, or 42 wt % or greater, or 44 wt % or greater, or 46 wt % or greater, or 48% or greater, or 50 wt % or greater, or 52 wt % or greater, or 54 wt % or greater, or 56 wt % or greater, or 58% or greater, or 60 wt % or greater, or 62 wt % or greater, or 64 wt % or greater, or 66 wt % or greater, or 68% or greater, or 70 wt % or greater, or 72 wt % or greater, or 74 wt % or greater, or 76 wt % or greater, or 78% or greater, while at the same time, 80 wt % or less, or 78 wt % or less, or 76 wt % or less, or 74 wt % or less, or 72 wt % or less, or 70 wt % or less, or 68 wt % or less, or 66 wt % or less, or 64 wt % or less, or 62 wt % or less, or 60 wt % or less, or 58 wt % or less, or 56 wt % or less, or 54 wt % or less, or 52 wt % or less, or 50 wt % or less, or 48 wt % or less, or 46 wt % or less, or 44 wt % or less, or 42 wt % or less, or 40 wt % or less, or 38 wt % or less, or 36 wt % or less, or 34 wt % or less, or 32 wt % or less, or 30 wt % or less, or 28 wt % or less, or 26 wt % or less, or 24 wt % or less, or 22 wt % or less, or 20 wt % or less based on the weight of the polymeric composition.

### Additives

The polymeric composition may comprise additional additives in the form of antioxidants, cross-linking co-agents, cure boosters and scorch retardants, processing aids, coupling agents, ultraviolet stabilizers (including UV absorbers), antistatic agents, additional nucleating agents, slip agents, lubricants, viscosity control agents, tackifiers, anti-blocking agents, surfactants, extender oils, acid scavengers, anti-drip agents (e.g., ethylene vinyl acetate) and metal deactivators. The polymeric composition may comprise from 0.01 wt % to 20 wt % of one or more of the additional additives.

The UV light stabilizers may comprise hindered amine light stabilizers (“HALS”) and UV light absorber (“UVA”) additives. Representative UVA additives include benzotriazole types such as TINUVIN 326™ light stabilizer and TINUVIN 328™ light stabilizer commercially available from Ciba, Inc. Blends of HAL's and UVA additives are also effective.

The antioxidants may comprise hindered phenols such as tetrakis [methylene (3,5-di-tert-butyl-4-hydroxyhydro-cinnamate)]methane; bis [(beta-(3,5-ditert-butyl-4-hydroxybenzyl)methylcarboxyethyl)]-sulphide, 4,4′-thiobis(2-methyl-6-tert-butylphenol), 4,4′-thiobis(2-tert-butyl-5-methylphenol), 2,2′-thiobis(4-methyl-6-tert-butylphenol), and thiodiethylene bis(3,5-di-tert-butyl-4-hydroxy)-hydrocinnamate; phosphites and phosphonites such as tris(2,4-di-tert-butylphenyl)phosphite and di-tert-butylphenyl-phosphonite; thio compounds such as dilaurylthiodipropionate, dimyristylthiodipropionate, and distearylthiodipropionate; various siloxanes; polymerized 2,2,4-trimethyl-1,2-dihydroquinoline, n,n′-bis(1,4-dimethylpentyl-p-phenylenediamine), alkylated diphenylamines, 4,4′-bis(alpha, alpha-dimethylbenzyl)diphenylamine, diphenyl-p-phenylenediamine, mixed di-aryl-p-phenylenediamines, and other hindered amine anti-degradants or stabilizers.

The processing aids may comprise metal salts of carboxylic acids such as zinc stearate or calcium stearate; fatty acids such as stearic acid, oleic acid, or erucic acid; fatty amides such as stearamide, oleamide, erucamide, or N,N′-ethylene bis-stearamide; polyethylene wax; oxidized polyethylene wax; polymers of ethylene oxide; copolymers of ethylene oxide and propylene oxide; vegetable waxes; petroleum waxes; non-ionic surfactants; silicone fluids, polysiloxanes, fluoropolymers, and/or fluoroelastomers.

### Compounding

The components of the polymeric composition can be added to a batch or continuous mixer for melt blending. The components can be added in any order or first preparing one or more masterbatches for blending with the other components. The melt blending may be conducted at a temperature above the highest melting polymer but lower than the maximum compounding temperature of 285° C. The melt-blended composition can then either be delivered to an extruder or an injection-molding machine or passed through a die for shaping into the desired article, or converted to pellets, tape, strip or film or some other form for storage or to prepare the material for feeding to a next shaping or processing step. Optionally, if shaped into pellets or some similar configuration, then the pellets, etc. can be coated with an anti-block agent to facilitate handling while in storage.

Examples of compounding equipment that may be used include internal batch mixers, continuous single or twin-screw mixers, or kneading continuous extruders. The type of mixer utilized, and the operating conditions of the mixer, will affect properties of the composition such as viscosity, volume resistivity, and extruded surface smoothness.

### Cable

The polymeric composition may be utilized in a cable. In some examples, the cable may be a coated conductor. In other examples, the cable may be a fiber optic cable. In coated conductor examples, the coated conductor includes a conductor and a coating on the conductor, the coating including the polymeric composition. The polymeric composition is at least partially disposed around the conductor to produce the coated conductor. The conductor may comprise a conductive metal or an optically transparent structure.

In optical fiber cable examples, the cable comprises a conductor and the polymeric composition is positioned around the conductor. The polymeric composition may be in the form of a buffer tube, one or more jacketing layers on the cable, and/or as other components in the cable. The conductor may include optical fibers or other transmissive components. The optical fiber cable may be a “loose buffer tube” design where buffer tubes are positioned radially around a central strength member, with a helical rotation to the buffer tubes along an axial length of the optical fiber cable. One or more conductors may be positioned within the buffer tube such that the buffer tube is positioned around the conductor. The buffer tubes may comprise, consist or consist essentially of the polymeric composition. As such, the buffer tube may be a polymeric tube. The buffer tubes are optionally filled with an optic cable grease or gel. Gel and grease compounds may include hydrocarbon-based greases incorporating hydrocarbon oils and/or polymer-based greases that use a low viscosity polymer formulated with hydrocarbon oils.

### EXAMPLES

### Materials

The following materials were used in the comparative examples (“CE”) and the inventive examples (“IE”).

MDH is magnesium hydroxide having a density of 2.36 g/cc and is commercially available as MAGNIFIN™ H5 from Magnifin Magnesiaprodukte GmbH & Co KG, Austria.

SI-MDH is vinyl silane treated magnesium hydroxide having a density of 2.36 g/cc and is commercially available as MAGNIFIN™ H5A from Magnifin Magnesiaprodukte GmbH & Co KG, Austria.

HDPE1 is a UNIPOL™ II bimodal polyethylene having a hexene comonomer, a density of 0.95 g/cc and a melt index (I₂) of 0.5 g/10 min. at 190° C., from The Dow Chemical Company, Midland, MI, USA.

HDPE2 is a bimodal polyethylene having a density of 0.955 g/cc and a melt index (I₂) of 0.3 g/10 min. at 190° C., that is commercially available as DGDA-1310NT from The Dow Chemical Company, Midland, MI, USA.

HDPE3 is a unimodal polyethylene having a density of 0.965 g/cc and a melt index (I₂) of 8 g/10 min. at 190° C., that is commercially available as DGDA-6944NT from The Dow Chemical Company, Midland, MI, USA.

HDPE4 is a unimodal polyethylene having a hexene comonomer, a density of 0.952 g/cc and a melt index (I₂) of 12 g/10 min. at 190° C., that is commercially available as DMDA-8810NT from The Dow Chemical Company, Midland, MI, USA.

HDPE5 is a bimodal polyethylene having a hexene comonomer, a density of 0.955 g/cc and a melt index (I₂) of 1.5 g/10 min. at 190° C., that is commercially available as DMDC-1250NT from The Dow Chemical Company, Midland, MI, USA.

HDPE6 is a bimodal polyethylene having a hexene comonomer, a density of 0.955 g/cc and a melt index (I₂) of 2.5 g/10 min. at 190° C., that is commercially available as DMDC-1270NT from The Dow Chemical Company, Midland, MI, USA.

MAH-g-LLDPE(1) is a maleic-anhydride-grafted plastomer having a density of 0.902 g/cc, a melt index of 3.3 g/10 min., and a maleic anhydride content of 0.45 wt %, that is commercially available from The Dow Chemical Company, Midland, MI, USA.

MAH-g-LLDPE(2) is a maleic-anhydride-grafted LLDPE having a density of 0.912 g/cc, a melt index of 2.1 g/10 min., and a maleic anhydride content of 2.4 wt %, that is commercially available from The Dow Chemical Company, Midland, MI, USA.

MAH-g-LLDPE(3) is a maleic-anhydride-grafted LLDPE having a density of 0.925 g/cc, a melt index of 2.0 g/10 min., and a maleic anhydride content of 1.8 wt %, that is commercially available from The Dow Chemical Company, Midland, MI, USA.

MAA Ionomer is a methacrylic acid-ethylene copolymer that is neutralized with Zn having 15 wt % methacrylic acid units, a density of 0.952 g/cc and a melt index of 14 g/10 min. that is commercially available from The Dow Chemical Company, Midland, MI, USA.

PDMS is polydimethylsiloxane oil that has a density of 0.977 g/cc, a viscosity of 60,000 centistokes and is commercially available from The Dow Chemical Company, Midland, MI, USA.

AO1 is a sterically hindered phenolic antioxidant having the chemical name pentaerythritol tetrakis(3-(3,5-di-tert-butyl-4-hydroxyphenyl) propionate), that is commercially available as IRGANOX 1010™ from BASF, Ludwigshafen, Germany.

DFDA is a halogen-free flame retardant filled polyolefin material having a density of 1.50 g/cc and is commercially available as UNIGARD™ DFDA-1638NT from The Dow Chemical Company, Midland, MI, USA.

### Sample Preparation for HFFR Compounds

Samples were produced by melt blending in a BRABENDER™ mixer. All samples (excluding commercial samples) were mixed in a lab scale, 250 gram BRABENDER™ mixing bowl with 250 gm capacity using BANBURY™ type mixing blades with the settings shown in Table 1. After melt mixing, the molten material was removed and placed between biaxially-oriented polyethylene terephthalate sheets and pressed into a sheet using a WABASH™ compression molding press at 23° C. The material was then cut into strips to enable pelletizing using a BERLYN™ pelletizing unit.

Pellets of each sample were then used to produce tape samples using a BRABENDER™ tape extruder with conditions shown in the Table 2. The tapes had dimensions of 1.58 mm thickness and about 51 mm width. Type 4a dog bone samples were die cut out in machine directions for tensile and elongation measurements per ASTM D638.

TABLE 1
BRABENDER ™ Mixing Parameters

| Setting | Unit | |
|---|---|---|
| Middle temperature | C. | 191 |
| Current | Amp | 7 |
| End temperature | C. | 187 |
| Speed | RPM | 55 |
| Mixing time | Min | 8 |

TABLE 2
BRABENDER ™ Tape Extrusion Parameters

| Setting | Unit | |
|---|---|---|
| Zone 1 | C. | 160 |
| Zone 2 | C. | 170 |
| Zone 3 | C. | 180 |
| Zone 4 | C. | 180 |
| Melt Temperature | C. | 185 |
| Extruder RPM | RPM | 60 |

### Sample Preparation for the Table 5 Resin Blends

The resin blends shown in Table 5 with two or more components were mixed in a lab scale, 250 gram BRABENDER™ mixing bowl with 250 gm capacity using BANBURY™ type mixing blades. The rotor speed was set at 40 RPM and the mixer temperature was set to 180° C.

The mixing process involved first adding the resins into the mixing bowl at a mixing speed of 15 RPM. Both heating zones were set for 180 C. After the resins began to melt, (0.4 wt %) AO1 (IRGANOX™ 1010) was added and mixed at 40 RPM for 6 minutes. The molten material was then removed and placed between mylar sheets and pressed into a sheet using a Wabash compression molding press at 23° C. The material was then used to make plaques for rheological measurements.

### Test Methods

### Melt Index

Melt index testing was carried out on a Tinius Olsen MP-993 testing unit. Melt index was measured at 210° C. with 21.6 kg weight and followed the ASTM D 1238 test procedure. For each melt property test the cylinder of the testing unit was charged with 6 grams of material and preheated for 6 minutes.

### Tensile and Elongation

Five type 4 dog bone specimens for each sample were die-cut from the tape samples in the machine direction. Tensile and elongation were completed on an INSTRON™ 4201 tensile testing machine using a 100 lbs load cell at 2 in/min strain rate per ASTM D638.

### Flexural Modulus

Plaques for flexural modulus were compression molded in a 3.18 mm 20 cm×20 cm. steel mold at 180° C. The samples were die cut to dimension of approximately 3 cm×1 cm. The test was conducted according to ASTM D790 with a crosshead speed of 1.27 mm/min and 51 mm support span.

### Cone Calorimetry

Samples for cone calorimetry testing were produced by compression molding and then die cutting to a size of 100 mm×100 mm×3 mm. Tests were completed per ASTM E1354 at a heat flux set at 50 kW/m². Samples were tested without a grid and the reported values are the average of 2-3 samples. The calorimetry results are expressed as a peak heat release rate (“PHRR”).

### Extruded Tape/Mandrel Bending Test

Tape samples were wrapped 1 complete wrap around a mandrel having a diameter of about 7.7 mm and held in that position for 10 seconds minimum. Any kinking or breaks were recorded for each sample.

### Dynamic Oscillatory Shear Testing

Unless indicated otherwise, all dynamic viscosities (η*) disclosed herein were calculated using Dynamic Oscillatory Shear (DOS) and are reported in pascal-seconds (Pa·s).

Samples were compression-molded into 1.3 mm thick×25 mm circular plaques at 180° C., for five minutes, under 25,000 psi pressure, in air. The sample was then taken out of the press, and allowed to cool.

A constant temperature frequency sweep was performed using a TA Instruments Advanced Rheometric Expansion System (ARES), equipped with 25 mm (diameter) parallel plates, under a nitrogen purge. Samples were placed on the plate and allowed to melt for five minutes at 190° C. The plates were then closed to a gap of 2 mm, the samples trimmed (extra sample that extends beyond the circumference of the 25 mm diameter plate was removed), and then the tests were started. The method had an additional five minute delay built in to allow for temperature equilibrium. The tests were performed at 190° C. over a frequency range of from 0.1 radians per second (rad/s) to 100 rad/s at a constant strain of 0.25%. The resulting values obtained from the measurement of G′ and G″ (dynamic storage and loss moduli, respectively) versus frequency were used to calculate the relaxation spectrum using the IRIS™ commercial software package. Respective values for the relaxation spectrum index (RSI) were then calculated from the relaxation spectra.

The RSI is determined by first subjecting the combined first and second ethylene-based polymers (“the polymer”) to a low shear deformation and measuring its response to the deformation using a rheometer. As is known in the art, based on the response of the polymer and the mechanics and geometry of the rheometer used, the relaxation modulus G(t) or the dynamic moduli G′(ω) and G″(ω) may be determined as functions of time t or frequency ω, respectively (see J. M. Dealy and K. F. Wissbrun, Melt Rheology and Its Role in Plastics Processing, Van Nostrand Reinhold, 1990, pp. 269-297). The mathematical connection between the dynamic and storage moduli is a Fourier transform integral relation, but one set of data may also be calculated from the other using the well known relaxation spectrum (see S. H. Wasserman, J. Rheology, Vol. 39, pp. 601-625 (1995)). Using a classical Maxwellian mechanical model a discrete relaxation spectrum consisting of a series of relaxations or “modes,” each with a characteristic intensity or “weight” and relaxation time, may be defined. Using such a spectrum, the moduli are re-expressed as:

$${G}^{′} ( ω ) = {\sum }_{i = 1}^{N} {g}_{i} \frac{{( {ωλ}_{i} )}^{2}}{1 + {( {ωλ}_{i} )}^{2}}$$

$${G}^{″} ( ω ) = {\sum }_{i = 1}^{N} {g}_{i} \frac{{ωλ}_{i}}{1 + {( {ωλ}_{i} )}^{2}}$$

$$G ( t ) = {\sum }_{i = 1}^{N} {g}_{i} exp ( - τ / {λ}_{i} )$$

where N is the number of relaxation modes and gᵢ and λᵢ are the weight and time, respectively, for each of the modes (see J. D. Ferry, Viscoelastic Properties of Polymers, John Wiley & Sons, 1980, pp. 224-263). Once the distribution of modes in the relaxation spectrum is calculated, the first and second moments of the distribution, which are analogous to Mₙ and M_{w}, the first and second moments of the molecular weight distribution, are calculated as follows:

$${g}_{I} = {\sum }_{i = 1}^{N} {g}_{i} / {\sum }_{i = 1}^{N} {g}_{i} / {λ}_{i}$$

$${g}_{II} = {\sum }_{i = 1}^{N} {g}_{i} {λ}_{i} / {\sum }_{i = 1}^{N} {g}_{i}$$

where RSI is defined as g_{II}/g_{I}.

### Gel Permeation Chromatography

The chromatographic system consisted of a PolymerChar GPC-IR (Valencia, Spain) high temperature GPC chromatograph equipped with an internal IR5 infra-red detector (IR5). The autosampler oven compartment was set at 165° Celsius and the column compartment and detectors were set at 155° Celsius. The columns used were 4 TOSOH TSKgel GMHHR-H (30) HT 30-micron particle size, mixed pore size columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 g/mol and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. Individually prepared polystyrene standards of 10,000,000 and 15,000,000 g/mol, both from Agilent Technologies, were also prepared, at 0.5 and 0.3 mg/mL respectively. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968)):

$${M}_{polyethylene} = A \times {( {M}_{polystyrene} )}^{B} \qquad ( EQ 1 )$$

where M is the molecular weight, A has a value of 0.4122 and B is equal to 1.0.

A third order polynomial was used to fit the respective polyethylene-equivalent calibration points.

The total plate count of the GPC column set was performed with decane which was introduced into blank sample via a micropump controlled with the PolymerChar GPC-IR system. The plate count for the chromatographic system should be greater than 12,000 for the 4 TOSOH TSKgel GMHHR-H (30) HT 30-micron particle size, mixed pore size columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 2-4, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 2 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 3 )$$

$${Mz}_{( GPC )} = \frac{{\sum }^{i} ( {IR}_{i} * {{M}_{{polyethylene}_{i}}}^{2} )}{{\sum }^{i} ( {IR}_{i} * {M}_{{polyethylene}_{i}} )} \qquad ( EQ 4 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate (nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate (effective)) for the entire run. After calibrating the system based on a flow marker peak, the effective flowrate (with respect to the narrow standards calibration) is calculated as Equation 5. Processing of the flow marker peak was done via the PolymerChar GPCOne™ Software. Acceptable flowrate correction is such that the effective flowrate should be within +/−0.5% of the nominal flowrate.

$$Flowrate ( effective ) = Flowrate ( nominal ) * ( RV ( FM Calibrated ) / RV ( FM Sample ) ) \qquad ( EQ 5 )$$

### Results

Table 3 provides the composition of the inventive examples (“IE”) and the comparative examples (“CE”) and Table 4 provides the associated testing properties of the examples. Table 5 provides relaxation spectrum index and gel permeation chromatography data on the inventive and comparative examples.

TABLE 3

| Material | CE1 | IE1 | CE2 | IE2 | CE3 | IE3 | CE4 | IE4 | CE5 | IE5 | CE6 | CE7 |
|---|---|---|---|---|---|---|---|---|---|---|---|---|
| MDH | 66 | 66 | 66 | | 66 | | 66 | 66 | 66 | | 66 | 66 |
| SI-MDH | | | | 66 | | 60 | | | | 60 | | |
| HDPE1 | 19.8 | | | | | | | | | | | |
| HDPE5 | | | | | | | | | | | 25.8 | |
| HDPE2 | | 19.35 | 12.9 | 19.35 | 12.9 | 23.85 | | 12.9 | | 15.9 | | 12.9 |
| HDPE3 | | 6.45 | 12.9 | 6.45 | | 7.95 | | | | | | 12.9 |
| HDPE4 | | | | | | | 25.8 | 12.9 | | 15.9 | | |
| HDPE6 | | | | | 12.9 | | | | 25.8 | | | |
| MAH-g- | 12 | | | | | | | | | | | |
| LLDPE(1) | | | | | | | | | | | | |
| MAH-g- | | 6 | 6 | 6 | 6 | 6 | 6 | 6 | | 6 | | |
| LLDPE(3) | | | | | | | | | | | | |
| MAH-g- | | | | | | | | | 6 | | 6 | 6 |
| LLDPE(2) | | | | | | | | | | | | |
| MAA | 1 | 1 | 1 | 1 | 1 | 1 | 1 | 1 | 1 | 1 | 1 | 1 |
| PDMS | 1 | 1 | 1 | 1 | 1 | 1 | 1 | 1 | 1 | 1 | 1 | 1 |
| AO1 | 0.2 | 0.2 | 0.2 | 0.2 | 0.2 | 0.2 | 0.2 | 0.2 | 0.2 | 0.2 | 0.2 | 0.2 |

TABLE 4

| | CE1 | IE1 | CE2 | IE2 | CE3 | IE3 | CE4 | IE4 | CE5 | IE5 | CE6 | CE7 |
|---|---|---|---|---|---|---|---|---|---|---|---|---|
| Bending | No | No | No | No | Break | No | Break | No | Break | No | No | No |
| | break | break | break | break | | break | | break | | break | break | break |
| Melt Index | 3.7 | 4.9 | 2.8 | 1.2 | 1.6 | 6.1 | 14.5 | 3.1 | 1 | 10.6 | 3.8 | 3.3 |
| (I₂₁) (g/10 | | | | | | | | | | | | |
| minutes) | | | | | | | | | | | | |
| Tensile | 18.3 | 24.4 | 24.3 | 22.2 | 23.6 | 23.5 | 22.6 | 22.9 | 23.7 | 25.1 | 23.2 | 23.6 |
| (mPa) | | | | | | | | | | | | |
| TE (%) | 29 | 24 | 10 | 25 | 16 | 44 | 11 | 24 | 13 | 45 | 19 | 17 |
| Flex | 1018 | 1579 | 1450 | 1548 | 1619 | 1896 | 1701 | 1632 | 1314 | 1578 | 1499 | 2062 |
| modulus (1% | | | | | | | | | | | | |
| sec, mPa) | | | | | | | | | | | | |
| DOS | 46,000 | 39,000 | NM- | 15,600 | 24,500 | 19,700 | 59,000 | 33,700 | 129.000 | 17,400 | NM | NM |
| Viscosity | | | | | | | | | | | | |
| (Pa · S) at | | | | | | | | | | | | |
| 0.1 rad/s | | | | | | | | | | | | |
| DOS | 416 | 495 | | 149 | 195 | 261 | 312 | 233 | 540 | 279 | | |
| Viscosity | | | | | | | | | | | | |
| (Pa · S) at | | | | | | | | | | | | |
| 100 rad/s | | | | | | | | | | | | |
| PHRR (kW/ | 150 | 164 | NM | 171 | NM | 202 | 160 | 160 | NM | 191 | NM | NM |
| m²) | | | | | | | | | | | | |

TABLE 5

| | Blend | | | | | |
|---|---|---|---|---|---|---|
| | Ratio | | | | | |
| RESINS or | (by | | Reference | | | |
| BLEND | weight) | RSI | Example | Mn | Mw | PDI |
| HDPE2/HDPE3 | (50/50) | 10.3 | CE2, CE7 | 14360 | 128860 | 8.97 |
| HDPE2/HDPE3 | (75/50) | 16.8 | IE1, IE2, | 13730 | 158638 | 11.55 |
| | | | IE3 | | | |
| HDPE2/HDPE4 | (50/50) | 19.4 | IE4, IE5 | 13520 | 138170 | 10.22 |
| HDPE2/HDPE6 | (50/50) | 46.5 | CE3 | 13640 | 149130 | 10.93 |
| HDPE4 | N/A | 6.8 | CE4 | 14100 | 88900 | 6.30 |
| HDPE5 | N/A | 28.0 | CE6 | 12030 | 117620 | 9.78 |
| HDPE6 | N/A | 14.8 | CE5 | 12520 | 100630 | 8.04 |

Referring now to Tables 3-5, it can be seen that CE1-CE7 fail to achieve one or more of the desired value of a PHRR of less than 250 kW/m² as measured according to ASTM E1354, an elongation of greater than 20% as measured according to ASTM D638, a flexural modulus of greater than 950 MPa as measured according to ASTM D790 and a dynamic oscillatory shear viscosity at 0.1 radians per second less than 46,000 Pa·s as measured according to ASTM D4440-15.

Unlike CE1-CE7, IE1-IE5 are able to achieve all of the desired properties. It can be seen from Table 5 that the HDPE blends (i.e., the combined first and second ethylene-based polymers) of the inventive examples all achieve a Relaxation Spectrum Index value of 10 to 25, a polydispersity index of 10 or greater and a dynamic oscillatory shear viscosity at 100 radians per second of 500 Pa·s or less (shown in Table 4) thereby enabling polymeric compositions to achieve the desired processing and mechanical property targets despite containing higher loadings of HFFR.

1. A polymeric composition, comprising:
a first ethylene-based polymer having a density of 0.93 g/cc to 0.97 g/cc as measured according to ASTM D792, wherein the first ethylene-based polymer has a melt index (I₂) of 0.8 g/10 minute or less as measured according to ASTM D1238;
a second ethylene-based polymer having a density of 0.93 g/cc to 0.97 g/cc as measured according to ASTM D792, wherein the second ethylene-based polymer has a melt index (I₂) of 3.0 g/10 minute or greater as measured according to ASTM D1238, wherein the combination of the first and second ethylene-based polymers has a Relaxation Spectrum Index value of 10 to 25, a polydispersity index of 10 or greater as measured according to Gel Permeation Chromatography, and a dynamic oscillatory shear viscosity at 100 radians per second of 500 Pa·S or less as measured according to ASTM D4440-15;
a compatibilizer; and
a flame retardant filler.

2. The polymeric composition of claim 1, wherein the compatibilizer is selected from the group consisting of a maleic anhydride grafted polymer, an acid copolymer, and an ionomer.

3. The polymeric composition of claim 1, wherein the flame retardant filler is a silane-treated flame retardant filler and the polymeric composition comprises from 10 wt % to 80 wt % of the silane treated flame retardant filler based on a total weight of the polymeric composition.

4. The polymeric composition of claim 1, wherein the polymeric composition comprises from 5 wt % to 30 wt % of the first ethylene-based polymer based on a total weight of the polymeric composition.

5. The polymeric composition of claim 1, wherein the polymeric composition comprises from 1 wt % to 20 wt % of the second ethylene-based polymer based on a total weight of the polymeric composition.

6. The polymeric composition of claim 1, wherein a weight ratio of the first ethylene-based polymer to the second ethylene-based polymer is from 1:1 to 3:1.

7. The polymeric composition of claim 1, wherein the first ethylene-based polymer has a melt index (I₂) of 0.5 g/10 min or less as measured according to ASTM D1238 and the second ethylene-based polymer has a melt index (I₂) of 6 g/10 min or greater as measured according to ASTM D1238.

8. The polymeric composition of claim 1, wherein the Relaxation Spectrum Index value of the combined first and second ethylene-based polymer is 15 to 21.

9. The polymeric composition of claim 1, wherein the polymeric composition exhibits a PHHR of less than 250 kW/m² as measured according to ASTM E1354, an elongation of greater than 20% as measured according to ASTM D638, a flexural modulus of greater than 950 MPa as measured according to ASTM D790.

10. A cable, comprising:
a conductor; and
a buffer tube positioned around the conductor and comprising the polymeric composition of claim 1.
